(19) United States
(12) Patent Application Publication
(10) Pub. No.: US 2021/0032725 A1
(43) Pub. Date: Feb. 4, 2021

(54) Methods of Rare Earth Metal Recovery from Electronic Waste

(71) Applicant: WARNER BABCOCK INSTITUTE FOR GREEN CHEMISTRY, LLC, Wilmington, MA (US)

(72) Inventors: John C. Warner, Wilmington, MA (US); Kethinni Chittibabu, Wilmington, MA (US); Debora Martino, Wilmington, MA (US)

(73) Assignee: WARNER BABCOCK INSTITUTE FOR GREEN CHEMISTRY, LLC, Wilmington, MA (US)

(21) Appl. No.: 17/073,758

(22) Filed: Oct. 19, 2020

Related U.S. Application Data
(63) Continuation of application No. PCT/US2019/028036, filed on Apr. 18, 2019.
(60) Provisional application No. 62/659,845, filed on Apr. 19, 2018.

(51) Int. Cl. C22B 59/00; C22B 1/248; C22B 7/00

(52) U.S. Cl. CPC C22B 59/00; C22B 7/007; C22B 1/248

(57) ABSTRACT

Provided herein are methods of recovering rare earth metals from metallic waste using extraction and precipitation processes. In one embodiment, this application discloses a method of selectively extracting one or more rare earth metals from a metallic substrate, the method comprising the steps of: (a) crushing the metallic substrate to produce a crushed composition; (b) treating the crushed composition with a strong acid solution to produce an extraction composition; (c) heating the extraction composition; (d) adding a rare earth chelating agent to the heated extraction composition to produce a precipitate; and (e) isolating the precipitate.

### SUMMARY

Described herein is a technology for the recovery of rare earth metals from certain metallic waste products—most importantly, electronic waste. Approximately 50 million tons of e-waste is produced every year. Rare earth metals, especially neodymium (Nd), praseodymium (Pr) and dysprosium (Dy), are present in small quantities in most of the super magnets typically used in many clean energy and high-tech applications, including motors in hybrid and electric vehicles (HEVs and EVs) and electric generators in wind turbines. Rare earth-containing magnets are also key components in most consumer electronic devices including computer hard disk drives (HDDs) and other computer parts, electric motors, household electrical appliances, smartphone audio speaker and receiver systems, headphones and many other gadgets. With improved separation and recycling methods, e-waste can be eliminated from landfills and the precious rare earth metals can be reused.

Provided herein are methods of recovering rare earth metals from metallic waste using extraction and precipitation processes. In one embodiment, this application discloses a method of selectively extracting one or more rare earth metals from a metallic substrate, the method comprising the steps of: (a) crushing the metallic substrate to produce a crushed composition; (b) treating the crushed composition with a strong acid solution to produce an extraction composition; (c) heating the extraction composition; (d) adding a rare earth chelating agent to the heated extraction composition to produce a precipitate; and (e) isolating the precipitate.

The following embodiments, aspects and variations thereof are exemplary and illustrative, and are not intended to be limiting in scope.

### DETAILED DESCRIPTION

Described herein is a method of selectively extracting one or more rare earth metals from a metallic substrate, the method comprising the steps of: (a) crushing the metallic substrate to produce a crushed composition; (b) treating the crushed composition with a strong acid solution to produce an extraction composition; (c) heating the extraction composition; (d) adding a rare earth chelating agent to the heated extraction composition to produce a precipitate; and (e) isolating the precipitate.

Definitions

Unless specifically noted otherwise herein, the definitions of the terms used are standard definitions used in the art of extraction and chemical sciences. Exemplary embodiments, aspects and variations are illustrated in the figures and drawings, and it is intended that the embodiments, aspects and variations, and the figures and drawings disclosed herein are to be considered illustrative and not limiting.

As used herein, the term “rare earth metal” refers to one of the following elements: cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb) and yttrium (Y). In some embodiments herein, the rare earth metals are those most commonly found in electronic waste: neodymium (Nd), praseodymium (Pr), and dysprosium (Dy).

The term “metallic substrate,” as used herein, refers to a metal-containing waste or waste component. In some embodiments, the metal-containing waste includes electronics such as computers, head actuators in computer hard disk drives, electric motors, household electrical appliances, smart phones and audio components like speaker and receiver systems, headphones and many other gadgets. Components that contain super magnets, such as smartphone speakers and audio receivers are preferred, as are many computer parts including hard drives, and speakers for audio systems.

As used herein, the term “strong acid” refers to acids with pKa between about −10 and +1. Strong acids include, but are not limited to, sulfuric acid (H₂SO₄), nitric acid (HNO₃), hydroiodic acid (HI), hydrobromic acid (HBr) and hydrochloric acid (HCl). These strong acids may be used in the described embodiments herein at concentrations ranging from 1.5N to 6N.

As used herein, the term “rare earth chelating agent” refers to a substance capable of chelating a rare earth metal in solution and causing the metal to precipitate out of solution. In some embodiments disclosed herein, the rare earth chelating agent is a sulfate, a phosphate or an oxalate, or a polyhydroxyl compound. In other embodiments, the rare earth chelating agent is selected from the group consisting of sodium hexametaphosphate, sodium carboxymethyl cellulose, diethylenetriamine-pentakis(methylphosphonic acid), sodium orthophosphate, sodium pyrophosphate tetrabasic, riboflavin phosphate sodium salt dihydrate, phytic acid sodium salt hydrate and sodium lignin sulfate. In still other embodiments, the rare earth chelating agent is selected from the group consisting of polymer ligands including poly(co-acrylic acid/maleic acid), copolymers of maleic acid with methacrylate, styrene, or other vinyl-containing monomers, polyvinylalcohol, poly(vinylacetate-co-vinylalcohol), and polyvinylpyridine.

Also provided herein is a method for recovering rare earth metals from metallic waste using extraction and precipitation processes. The method comprises the steps of: (a) crushing the metallic substrate to produce a crushed composition; (b) treating the crushed composition with a strong acid solution to produce an extraction composition; (c) heating the extraction composition; (d) adding a rare earth chelating agent to the heated extraction composition to produce a precipitate; and (e) isolating the precipitate.

In the first step, the metallic waste is crushed to aid in the extraction process. Crushing is accomplished using a blender, crusher, or any other tool commonly used in crushing metallic waste. The resultant crushed composition may optionally be concentrated by separating plastic and steel sheets from magnetic components using gravity and a sink and float process. (Materials are placed in a liquid medium and then separated by density: materials of lower specific gravity float on the liquid surface, while materials of higher specific gravity sink to the bottom.)

The optionally-concentrated crushed composition is then treated with or exposed to a strong acid to produce an extraction composition. The extraction composition is then exposed to a temperature between about 20 and about 80° C. for a time period ranging from about five to about 60 minutes to completely dissolve the desired material. The strong acid in the extraction composition selectively dissolves the rare earth metals, leaving the stainless-steel components mostly intact.

Following the heating step, a rare earth chelating agent is added to the extraction composition to a final concentration of between about 0.1% and about 10% (in distilled ionized (DI) water). In some embodiments, the final concentration is between about 1% and about 5%. The composition is then allowed to react for between about 5 and about 300 minutes or until the rare earth metals have precipitated from the solution. After the chelating agent has caused the precipitation of the desired rare earth metals, the precipitate is washed with DI water or aqueous solution to obtain the rare-earth metal-containing precipitate solids. The precipitate, if needed, can be sintered at temperatures ranging from about 600 to about 1000° C. to remove the organic materials.

In alternative embodiments, the rare earth chelating agent is either (a) immobilized on glass or polystyrene beads or (b) formed into particles of about 100 nm to about 100 micron thickness and crosslinked to become insoluble when added to the extracting solution. After addition, the rare earth metals are subsequently released from the beads or particles by changing the pH of the solution or using a second extractant for further purification. If used, the second extractant may be selected from 2-ethylhexyl phosphonic acid mono-2-ethylhexyl ester (PC-88A), and di-(2-ethylhexyl) phosphoric acid. The second extractant may be diluted in Prep Solvent-70 (3M Corporation, St. Paul, Minn.), hexane, octane, cyclohexanone, chloroform, 1-octanol, or toluene and exposed to rare earth containing beads. The beads or particles are then returned to their original state and are reusable.

### EXAMPLES

### Example 1

15 smartphone (iPhone 6) receiver assemblies (9.3 grams) were dry blended in an industrial blender for 30 seconds to separate the parts. The entire contents of the blender were added to 350 mL water in a beaker. The floating plastic and metal sheets were removed by scooping. The remaining contents of the beaker were filtered off and dried. The recovered weight of magnet rich material was calculated as 5.67 g, while the plastic and stainless steel sheet weighed about 3.56 g. The concentrated magnetic components were used for rare earth metal extraction and subsequent precipitation.

### Example 2

10 smartphone (iPhone 6) speaker assemblies were weighed (33.52 g) and dry blended in an industrial blender at low speed for 30 seconds and the contents were poured into 80 mL of 3N hydrochloric acid. The mixture was heated at 80° C. for 1 hour and the contents were filtered. Most of the plastic, stainless steel and plastic-coated copper wire were not affected by the acid treatment, while the magnetic material completely dissolved, forming a grey solution. The filtered solution was used for precipitation studies.

### Example 3

10 smartphone (iPhone 6) speaker assemblies were weighed (33.52 g) and dry blended in an industrial blender at low speed for 30 seconds and the contents were poured into 80 mL of 3N sulfuric acid. The mixture was heated at 80° C. for 1 hour and the contents were filtered. Most of the plastic, stainless steel and polymer-coated copper wire were not affected by the acid treatment, while the magnetic material completely dissolved, forming a clear, grey solution. The filtered solution was used for precipitation studies.

### Example 4

A 1 mL solution of 5% sodium hexametaphosphate in DI was added to 5 mL of the solution obtained in Example 3 at room temperature. The cloudy solution formed was allowed to subsequently precipitate by leaving it overnight. The precipitate was filtered, washed with water and dried. The weight of the dried powder was 1.36 g.

### Example 5

A 1 mL solution of 5% diethylenetriaminepentakis(methyl-phosphonic acid) in DI was added to 5 of the solution obtained in Example 3 at room temperature. The cloudy solution formed was allowed to subsequently precipitate by leaving it overnight. The precipitate was filtered, washed with water and dried. The weight of the dried powder was 1.26 g.

### Example 6

A 1 mL solution of 5% sodium lignin sulfonate in DI was added to 5 mL of the solution obtained in Example 3 at room temperature. The cloudy solution formed was allowed to subsequently precipitate by leaving it overnight. The precipitate was filtered, washed with water and dried. The weight of the dried powder was 1.76 g.

### Example 7

A 1 mL solution of 5% riboflavin 5′ phosphate sodium salt dihydrate in DI was added to 5 mL of the solution obtained in Example 3 at room temperature. The cloudy solution formed was allowed to subsequently precipitate by leaving it overnight. The precipitate was filtered, washed with water and dried. The weight of the dried powder was 1.74 g.

### Example 8

The dry powder obtained in Examples 4 to 7 were sintered at 600° C. for 45 minutes to remove organic matter, which resulted in weight losses in the range of 21% to 28%. The remaining material was observed to be pure rare earth compounds (sulfates or phosphates).

While a number of exemplary embodiments, aspects and variations have been provided herein, those of skill in the art will recognize certain modifications, permutations, additions and combinations and certain sub-combinations of the embodiments, aspects and variations. It is intended that the following claims are interpreted to include all such modifications, permutations, additions and combinations and certain sub-combinations of the embodiments, aspects and variations are within their scope. The entire disclosures of all documents cited throughout this application are incorporated herein by reference.

What is claimed is:

1. A method of selectively extracting one or more rare earth metals from a metallic substrate, the method comprising the steps of:
(a) crushing the metallic substrate to produce a crushed composition;
(b) treating the crushed composition with a strong acid solution to produce an extraction composition;
(c) heating the extraction composition;
(d) adding a rare earth chelating agent to the heated extraction composition to produce a precipitate; and
(e) isolating the precipitate.

2. The method of claim 1 wherein the rare earth metal is selected from the group consisting of neodymium (Nd), praseodymium (Pr) and dysprosium (Dy).

3. The method of claim 1 wherein the metallic substrate is a magnet or supermagnet.

4. The method of claim 1 wherein the metallic substrate is an audio component.

5. The method of claim 1 wherein step (a) is performed using a blender.

6. The method of claim 1 wherein the strong acid is sulfuric acid.

7. The method of claim 6 wherein the strong acid solution is 3N sulfuric acid.

8. The method of claim 1 wherein step (c) is performed by heating the extraction at 80° C.

9. The method of claim 1 wherein step (c) is performed for 30 minutes or less.

10. The method of claim 1, wherein the additional step of removing undissolved material from the extraction composition is inserted between steps (c) and (d).

11. The method of claim 10 wherein the rare earth chelating agent is selected from the group consisting of a sulfate, a phosphate or an oxalate.

12. The method of claim 10 wherein the rare earth chelating agent is selected from the group consisting of sodium hexametaphosphate, sodium carboxymethyl cellulose, diethylenetriamine-pentakis(methylphosphonic acid), sodium orthophosphate, riboflavin phosphate sodium salt dihydrate, and sodium lignin sulfate.

13. The method of claim 1, further comprising step (f), washing the precipitate with water.
